(19) United States
(12) Patent Application Publication
(10) Pub. No.: US 2017/0097742 A1
(43) Pub. Date: Apr. 6, 2017

(54) GENERATING DASHBOARDS USING A MOBILE COMPUTING DEVICE

(71) Applicant: salesforce.com, inc., San Francisco, CA (US)

(72) Inventors: Yuseung Kim, San Francisco, CA (US); Edward Charles Mengel, III, San Francisco, CA (US); Qingqing Liu, Dublin, CA (US); Jean Elie Bovet, Los Angeles, CA (US)

(21) Appl. No.: 14/872,333

(22) Filed: Oct. 1, 2015

(51) Int. Cl. G06F 3/0482; G06F 3/0484

(52) U.S. Cl. CPC G06F 3/0482; G06F 3/04842; G06F 3/04847

(57) ABSTRACT

Some embodiments of the present invention include a method for generating a dashboard using a display screen of a mobile computing system and includes displaying one or more dataset identifiers on a display screen of a mobile computing system. Based on detecting a selection of a dataset identifier, displaying one or more widgets on the display screen of the mobile computing system. Based on detecting a selection of a first widget, configuring the first widget to operate with a dataset associated with the selected dataset identifier. The first widget is then added to the dashboard based on completion of configuring of the first widget. Similar operations may be performed to add a second widget to the dashboard. Viewing the data in the dataset is possible by interacting with the first widget and the second widget in the dashboard.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to data processing, and more specifically relates to mobile analytics and the generation of dashboards.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Dashboards are generally designed to enable easy access and interpretation of data. There are many tools to generate dashboards. However, existing tools are developed for computer systems that have large display screens like desktop computer systems and therefore are particularly inefficient when computer systems with small display screens such as smart phones are more commonly used. Thus, there is a need for a more convenient and user-friendly technology for generating dashboards using a computer system having limited screen space, such as a smartphone or other mobile computing systems.

### BRIEF DESCRIPTION OF THE DRAWINGS

The included drawings are for illustrative purposes and serve only to provide examples of possible structures and process steps for the disclosed techniques. These drawings in no way limit any changes in form and detail that may be made to embodiments by one skilled in the art without departing from the spirit and scope of the disclosure.

FIG. 1 shows a diagram of an example computing system 102 that may be used with some embodiments of the present invention.

FIG. 2 shows a diagram of an example network environment that may be used with some embodiments of the present invention.

FIG. 3 shows an example display subsystem, in accordance with some embodiments.

FIGS. 4A through 4C show examples of display screens of a mobile computing system that enable selecting a dataset and selecting a widget to generate a dashboard, in accordance with some embodiments.

FIGS. 5A through 5C show examples of configuring a widget, in accordance with some embodiments.

FIG. 5D shows an example of a display screen with multiple widget boundaries, in accordance with some embodiments.

FIG. 6A show an example of a dashboard with configured widgets, in accordance with some embodiments.

FIG. 6B shows an example of a dashboard with account owner information updated to a specific account owner, in accordance with some embodiments.

FIG. 6C shows an example of a display screen to save a dashboard, in accordance with some embodiments.

FIG. 7 shows a flowchart of an example process for generating a dashboard when using a mobile computing system, performed in accordance with some embodiments.

FIG. 8A shows a system diagram 800 illustrating architectural components of an applicable environment, in accordance with some embodiments.

FIG. 8B shows a system diagram further illustrating architectural components of an applicable environment, in accordance with some embodiments.

FIG. 9 shows a system diagram 910 illustrating the architecture of a multitenant database environment, in accordance with some embodiments.

FIG. 10 shows a system diagram 910 further illustrating the architecture of a multi-tenant database environment, in accordance with some embodiments.

### DETAILED DESCRIPTION

Applications of systems and methods according to one or more embodiments are described in this section. These examples are being provided solely to add context and aid in the understanding of the present disclosure. It will thus be apparent to one skilled in the art that the techniques described herein may be practiced without some or all of these specific details. In other instances, well known process steps have not been described in detail in order to avoid unnecessarily obscuring the present disclosure. Other applications are possible, such that the following examples should not be taken as definitive or limiting either in scope or setting.

In the following detailed description, references are made to the accompanying drawings, which form a part of the description and in which are shown, by way of illustration, specific embodiments. Although these embodiments are described in sufficient detail to enable one skilled in the art to practice the disclosure, it is understood that these examples are not limiting, such that other embodiments may be used and changes may be made without departing from the spirit and scope of the disclosure.

As used herein, the term “multi-tenant database system” refers to those systems in which various elements of hardware and software of the database system may be shared by one or more customers. For example, a given application server may simultaneously process requests for a great number of customers, and a given database table may store rows for a potentially much greater number of customers.

The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more embodiments may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

As used herein, the term “mobile computing system” refers to a smartphone, smartwatch, tablet computer, notebook or laptop computer, handheld computer, mobile Internet device, wearable technology, or other mobile electronic device that includes processing and display capability. The term “widget” may refer to a simple application that is designed to perform a specific task such as, for example, displaying data in a certain chart format. There may be multiple widgets, and each may perform a different task. A widget may be a reusable component and may be used with other widgets to form a more complex application such as, for example, a dashboard.

For some embodiments, methods and systems for generating a dashboard using a computing system with a small display screen includes displaying one or more dataset identifiers on a display screen of a mobile computing system. Based on detecting a selection of a dataset identifier, displaying one or more widgets on the display screen of the mobile computing system. Based on detecting a selection of a first widget, configuring the first widget to operate with a dataset associated with the selected dataset identifier. The first widget is then added to the dashboard based on completion of configuring of the first widget. Similar operations may be performed to add a second widget to the dashboard. Viewing the data in the dataset is possible by interacting with the first widget and the second widget in the dashboard.

The disclosed embodiments may include a method for generating a dashboard using a display screen of a mobile computing system. The method includes displaying one or more dataset identifiers on a display screen of a mobile computing system. Based on detecting a selection of a dataset identifier, displaying one or more widgets on the display screen of the mobile computing system. Based on detecting a selection of a first widget, configuring the first widget to operate with a dataset associated with the selected dataset identifier. The first widget is then added to the dashboard based on completion of configuring of the first widget. Similar operations may be performed to add a second widget to the dashboard. Viewing the data in the dataset is possible by interacting with the first widget and the second widget in the dashboard.

The disclosed embodiments may include an apparatus for generating a dashboard using a display screen of a mobile computing system and include a processor, and one or more stored sequences of instructions which, when executed by the processor, cause the processor to display one or more datasets on a display screen of a mobile computing system using associated dataset identifiers, each dataset identifiers including a description of the dataset, each data set including one or more fields. Based on detecting a selection of a data set identifier, displaying one or more widgets on the display screen of the mobile computing system. Based on detecting a selection of a first widget, configuring the first widget to operate with a dataset associated with the selected dataset identifier. The first widget is then added to the dashboard based on completion of configuring of the first widget. Similar operations may be performed to add a second widget to the dashboard. Viewing the data in the dataset is possible by interacting with the first widget and the second widget in the dashboard. Operations of the first widget and the second widget are dynamically linked.

The disclosed embodiments may include a machine-readable medium carrying one or more sequences of instructions for displaying information, which instructions, when executed by one or more processors, causes the one or more processors to display one or more datasets on a display screen of a mobile computing system using associated dataset identifiers, each dataset identifiers displayed with a description of the dataset, each data set including one or more fields. Based on detecting a selection of a data set identifier, displaying one or more widgets on the display screen of the mobile computing system. Based on detecting a selection of a first widget, configuring the first widget to operate with a dataset associated with the selected dataset identifier. The first widget is then added to the dashboard based on completion of configuring of the first widget. Similar operations may be performed to add a second widget to the dashboard. Viewing the data in the dataset is possible by interacting with the first widget and the second widget in the dashboard. Operations of the first widget and the second widget are dynamically linked.

The disclosed embodiments may be related to generating a dashboard using a display screen with limited screen space such as a display screen of a mobile computing system. The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

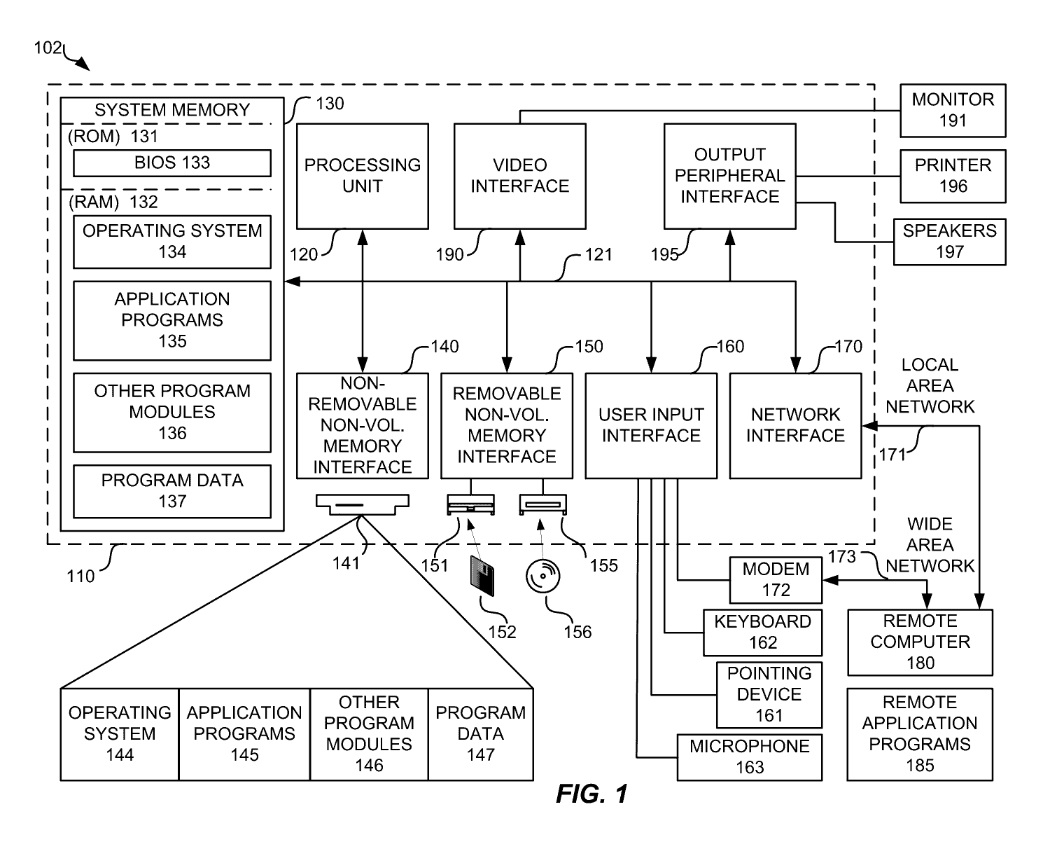

FIG. 1 is a diagram of an example computing system that may be used with some embodiments of the present invention. The computing system 102 may be used by a user to view information associated with a multi-tenant database environment. For example, the multi-tenant database environment may be associated with the services provided by Salesforce.com®. The computing system 102 may also be used to generate a dashboard using one or more widgets. The dashboard may then be used to view data associated with a dataset.

The computing system 102 is only one example of a suitable computing system, such as a mobile computing system, and is not intended to suggest any limitation as to the scope of use or functionality of the design. Neither should the computing system 102 be interpreted as having any dependency or requirement relating to any one or combination of components illustrated. The design is operational with numerous other general purpose or special purpose computing systems. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, mini-computers, mainframe computers, distributed computing environments that include any of the above systems or devices, and the like. For example, the computing system 102 may be implemented as a mobile computing system such as one that is configured to run with an operating system (e.g., iOS) developed by Apple Inc. of Cupertino, Calif. or an operating system (e.g., Android) that is developed by Google Inc. of Mountain View, Calif.

Some embodiments of the present invention may be described in the general context of computing system executable instructions, such as program modules, being executed by a computer. Generally, program modules include routines, programs, objects, components, data structures, etc. that performs particular tasks or implement particular abstract data types. Those skilled in the art can implement the description and/or figures herein as computer-executable instructions, which can be embodied on any form of computing machine readable media discussed below.

Some embodiments of the present invention may also be practiced in distributed computing environments where tasks are performed by remote processing devices that are linked through a communications network. In a distributed computing environment, program modules may be located in both local and remote computer storage media including memory storage devices.

Referring to FIG. 1, the computing system 102 may include, but are not limited to, a processing unit 120 having one or more processing cores, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

The computing system 102 typically includes a variety of computer readable media. Computer readable media can be any available media that can be accessed by computing system 102 and includes both volatile and nonvolatile media, removable and non-removable media. By way of example, and not limitation, computer readable media may store information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 102. Communication media typically embodies computer readable instructions, data structures, or program modules.

The system memory 130 may include computer storage media in the form of volatile and/or nonvolatile memory such as read only memory (ROM) 131 and random access memory (RAM) 132. A basic input/output system (BIOS) 133, containing the basic routines that help to transfer information between elements within computing system 102, such as during start-up, is typically stored in ROM 131. RAM 132 typically contains data and/or program modules that are immediately accessible to and/or presently being operated on by processing unit 120. By way of example, and not limitation, FIG. 1 also illustrates operating system 134, application programs 135, other program modules 136, and program data 137.

The computing system 102 may also include other removable/non-removable volatile/nonvolatile computer storage media. By way of example only, FIG. 1 also illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as, for example, a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computing system 102. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. The operating system 144, the application programs 145, the other program modules 146, and the program data 147 are given different numeric identification here to illustrate that, at a minimum, they are different copies.

A user may enter commands and information into the computing system 102 through input devices such as a keyboard 162, a microphone 163, and a pointing device 161, such as a mouse, trackball or touch pad or touch screen. Other input devices (not shown) may include a joystick, game pad, scanner, or the like. These and other input devices are often connected to the processing unit 120 through a user input interface 160 that is coupled with the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computing system 102 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computing system 102. The logical connections depicted in [symbol] FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computing system 102 may be connected to the LAN 171 through a network interface or adapter 170. When used in a WAN networking environment, the computing system 102 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computing system 102, or portions thereof, may be stored in a remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that some embodiments of the present invention may be carried out on a computing system such as that described with respect to FIG. 1. However, some embodiments of the present invention may be carried out on a server, a computer devoted to message handling, handheld devices, or on a distributed system in which different portions of the present design may be carried out on different parts of the distributed computing system.

Another device that may be coupled with the system bus 121 is a power supply such as a battery or a Direct Current (DC) power supply) and Alternating Current (AC) adapter circuit. The DC power supply may be a battery, a fuel cell, or similar DC power source needs to be recharged on a periodic basis. The communication module (or modem) 172 may employ a Wireless Application Protocol (WAP) to establish a wireless communication channel. The communication module 172 may implement a wireless networking standard such as Institute of Electrical and Electronics Engineers (IEEE) 802.11 standard, IEEE std. 802.11-1999, published by IEEE in 1999.

Examples of mobile computing systems may be a laptop computer, a tablet computer, a Netbook, a smart phone, a personal digital assistant, or other similar device with on board processing power and wireless communications ability that is powered by a Direct Current (DC) power source that supplies DC voltage to the mobile computing system and that is solely within the mobile computing system and needs to be recharged on a periodic basis, such as a fuel cell or a battery.

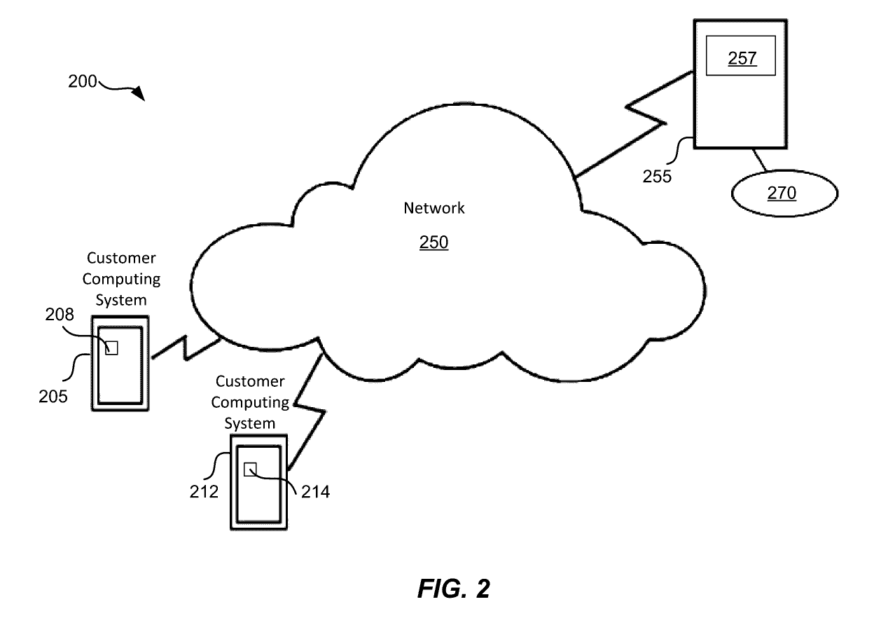

FIG. 2 shows a diagram of an example network environment that may be used with some embodiments of the present invention. Network environment 200 includes computing systems 205 and 212. One or more of the computing systems 205 and 212 may be a mobile computing system. The computing systems 205 and 212 may be connected to the network 250 via a cellular connection or via a Wi-Fi router (not shown). The network 250 may be the Internet. The computing systems 205 and 212 may be coupled with server computing system 255 via the network 250.

The computing systems 205 may include application module 208. A user may use the computing system 205 and the application module 208 to connect to and communicate with the server computing system 255 and log into application 257 (e.g., a Salesforce.com® application). The server computing system 255 may be coupled with database 270. The server computing system 255 may be associated with an entity (e.g., Salesforce.com®). The user may be associated with a customer of the entity.

The user may use the computing system 205 to generate a dashboard to view data associated with a dataset which may be stored in the database 270. The dashboard may be generated using widgets that may be downloaded from the server computing system 255 via the network 250.

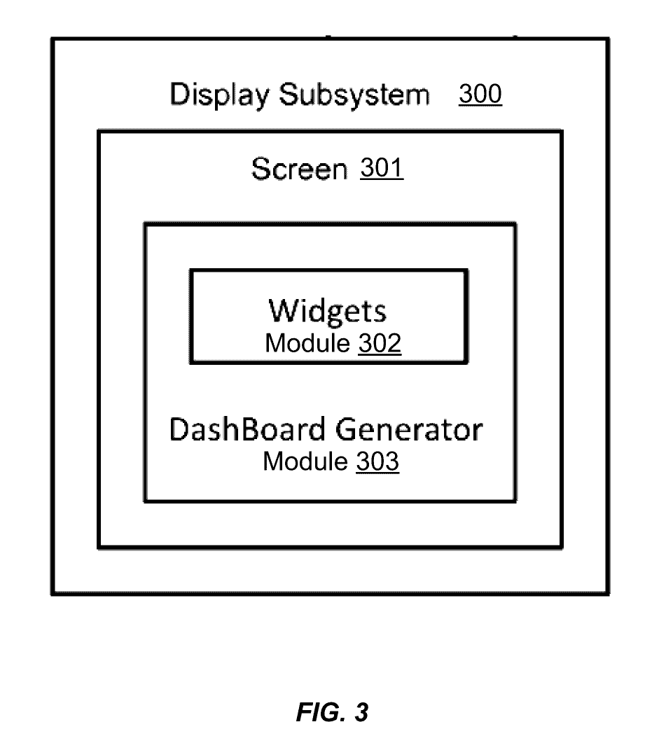

FIG. 3 shows an example display subsystem, in accordance with some embodiments. Display subsystem 300 may be associated with a computing system that is used to enable generating dashboards. The display subsystem 300 represents hardware (such as display devices) and software (such as drivers) components that provide a display having visual, tactile, or both elements for a user to interact with the computing system. The display subsystem 300 may include a display screen 301 operable to display dashboards and display screens associated with generating dashboards.

The computing system includes a dashboard generator module 303 configured to display options on a display screen with limited screen space to enable generating dashboards. The computing system includes a widget module 302 configured to display one or more widgets on the display screen. The widget module 302 may be included in the dashboard generator module 303, or it may be independent of the dashboard generator module 303. The widgets may be configured to operate on the data included in a dataset. For example, a widget may be a vertical chart widget and may be configured to display data in a dataset using a vertical chart. As another example, a widget may be pie chart widget and may be configured to display data in a dataset using a pie chart.

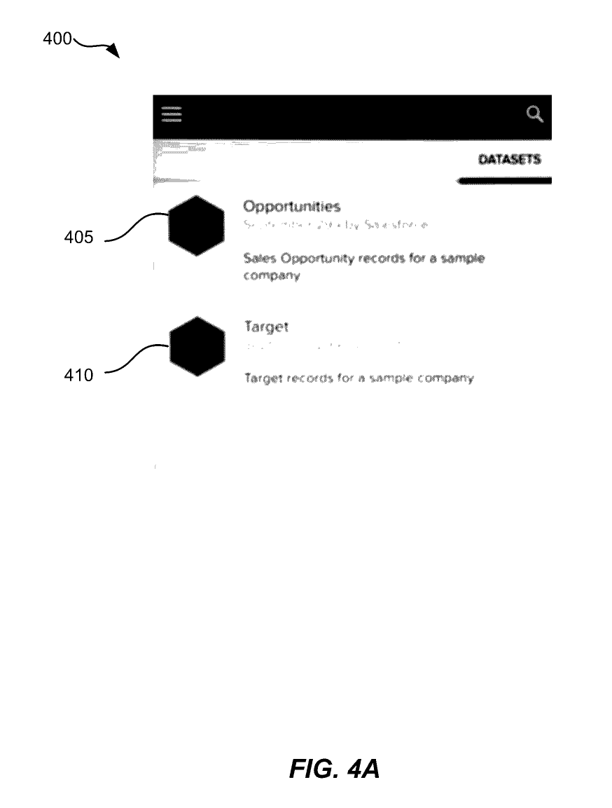

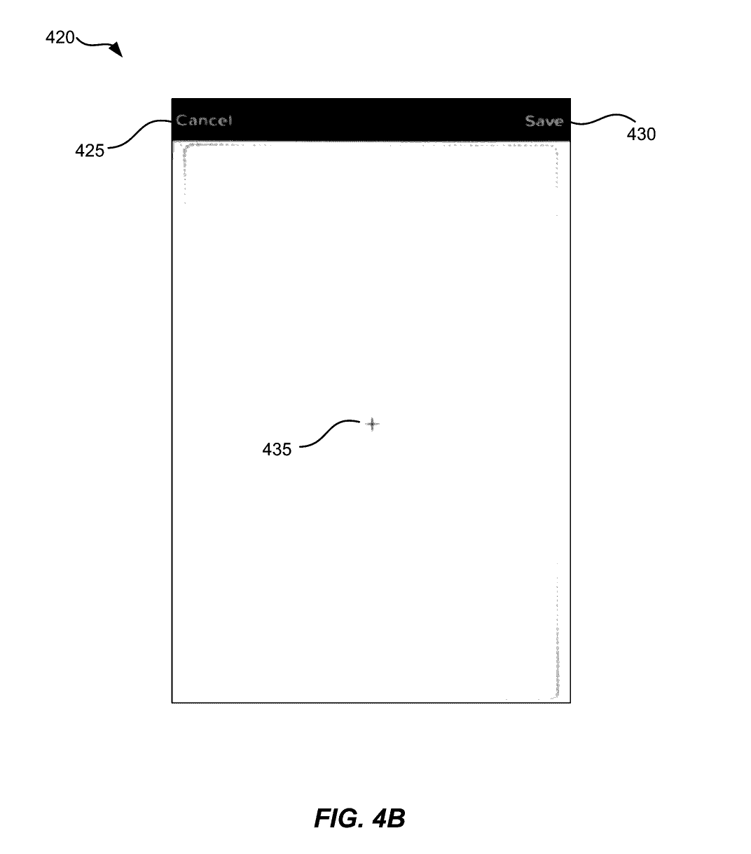

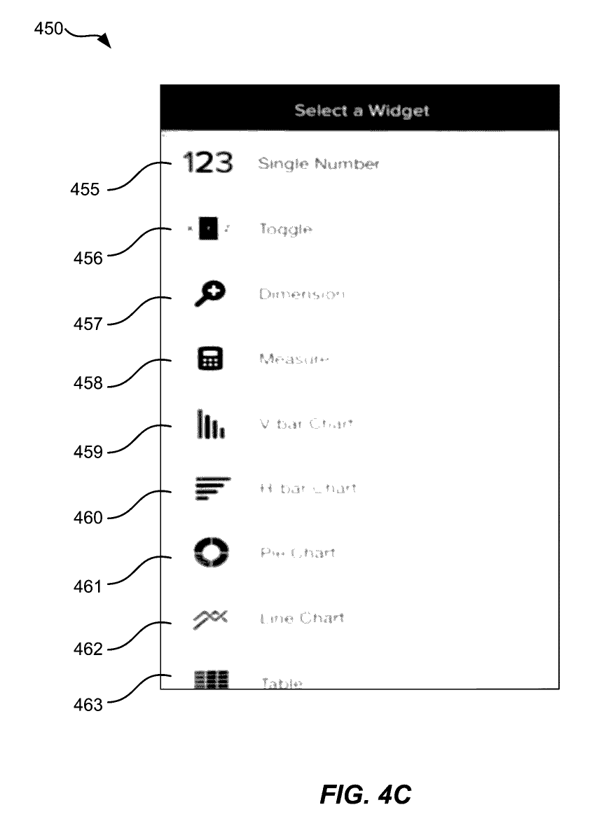

FIG. 4A illustrates an example display screen associated with the dashboard generator module, in accordance with some embodiments. A computing system may be a mobile computing system and may have a small display screen. Dataset display screen 400 may display a group of one or more dataset identifiers which correspond to datasets that a user may have access to. The dataset display screen 400 may be displayed based on selecting, for example, an option or an application to generate a dashboard. The dataset identifiers may include, for example, opportunity dataset identifier 405 and target dataset identifier 410. Each dataset identifier may be displayed along with description about the associated dataset. For some embodiments, a process of generating a dashboard may be initiated by first selecting a dataset identifier such as, for example, the opportunity dataset identifier 405.

FIG. 4B illustrates an example display screen associated with the dashboard generator after selecting a dataset has been selected, in accordance with some embodiments. Display screen 420 may be presented as a blank screen to represent a blank dashboard where the desired widgets may be assembled. Display screen 420 may include an add widget indicator 435 such as, for example, a “plus” symbol, to enable a user to start adding widgets within its associated boundary (shown as the dotted lines). For example, when an area on the display screen near or at the “plus” symbol 435 is touched, the widget module 302 may cause a widget display screen to be displayed. The display screen 420 may also include a “cancel” option 425 and a “save” option 430. The “cancel” option 425 may cause the dashboard generator module 303 to display the dataset display screen 400. The “save” option 430 may cause the dashboard generator module 303 to save the dashboard being generated.

FIG. 4C illustrates an example widget display screen, in accordance with some embodiments. Widget display screen 450 may display a collection of widgets that can be used to generate the dashboard. In this example, the collection of widgets may include “single number” widget 455, “toggle” widget 456, “dimension” widget 457, “measure” widget 458, “vertical bar chart” widget 459, “horizontal bar chart” widget 460, “pie chart” widget 461, “line chart” widget 462, and “table” widget 463. The number of widgets to be displayed may not be limited to those shown in the widget display screen 450. For some embodiments, the widgets may be available in a widget library associated with the server computing system 255, and may be downloaded to the computing system that is used to generate the dashboard. The list of widgets may be scrollable to view all of the available widgets. When a widget is selected, it may be added to a dashboard. For example, when a user touches a portion of the display screen that is near or at the “single number” widget 455, the dashboard generator module 303 may cause the “single number” widget 455 to be added to a dashboard.

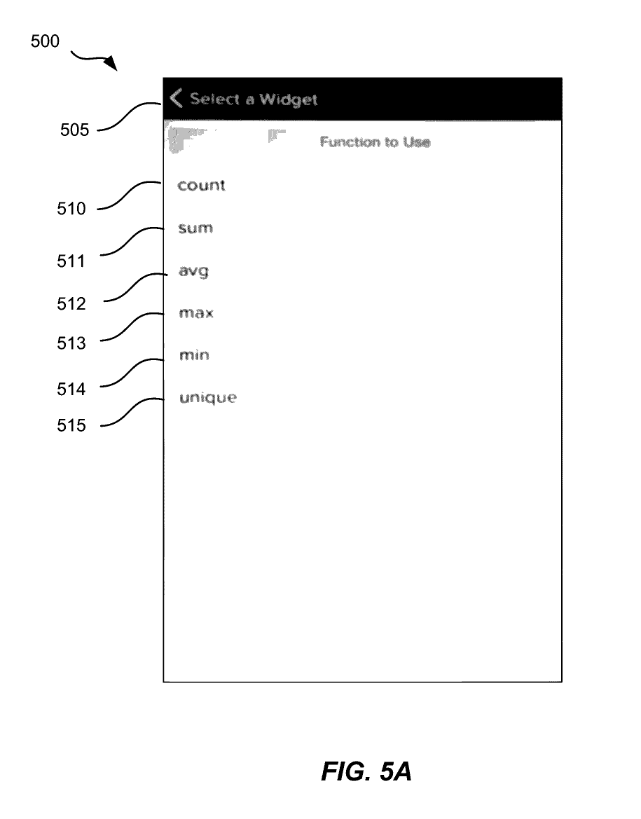

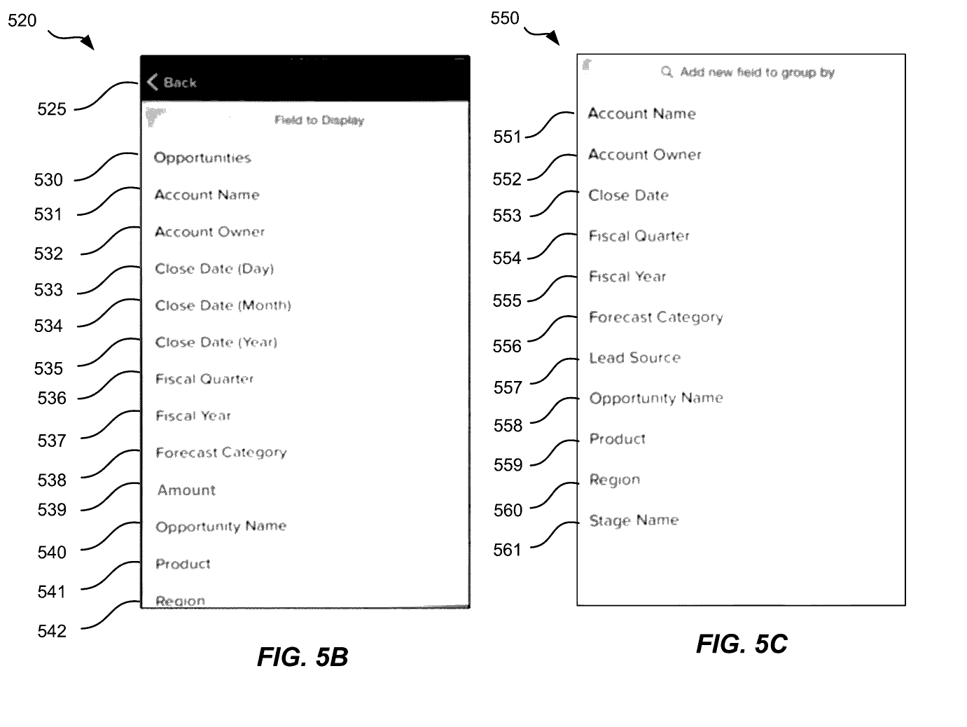

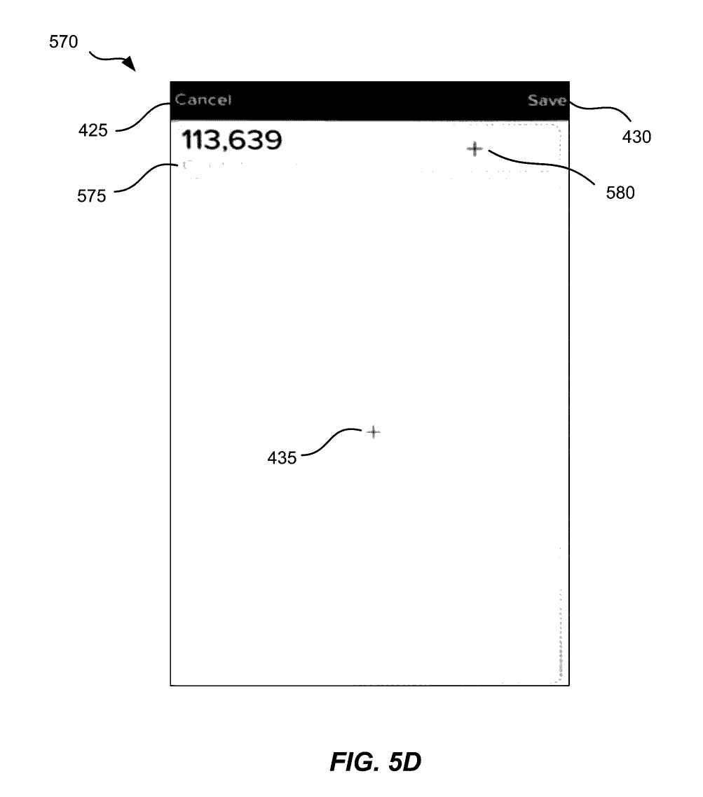

For some embodiments, when a widget is selected, the dashboard generator module 303 may display one or more display screens to enable configuring the selected widget. Configuring a widget may include specifying functions and field identifiers for the widget to operate. For some embodiments, each widget may be associated one or more functions related to operation of the widget. For example, when the “single number” widget 455 shown in FIG. 4C is selected, the dashboard generator module 303 may display the function display screen 500, as shown in FIG. 5A. In this example, the list of functions shown on the function display screen 500 may include “count” function 510, “sum” function 511, “average” function 512, “maximum” function 513, “minimum” function 514 and “unique” function 515. As may be noted, each of these functions further configure how the single number widget 455 is to operate. The list of functions may be scrollable to view all of the available functions.

When a user touches a portion of the display screen that is near or at the “select a widget” option 505, the dashboard generator module 303 may display the widget display screen 450 to enable the user to select a different widget.

For some embodiments, when a function on the function display screen 500 is selected, the dashboard generator module 303 may display one or more field identifiers associated with the selected dataset. A field identifier corresponds to a field of a dataset, and selecting a field identifier configures a widget to operate on the corresponding field of the dataset. For some embodiments, a field may be text-based, numeric-based, or alpha-numeric based.

Depending on how a widget operates, some or all of the field identifiers may be available for configuration. For example, a text field may not be available for a widget that operates only on numbers. When a function such as the count function 510 shown in FIG. 5A is selected, the dashboard generator module 303 may display the field display screen 520, shown in FIG. 5B. In this example, the list of field identifiers shown on the field display screen 520 may include “opportunities” field 530, “account name” field 531, “account owner” field 532, “close date by day” field 533, “close date by month” field 534, “close date by year” field 535, “fiscal quarter” field 536, “fiscal year” field 537, “forecast category” field 538, “amount” field 539, “opportunity name” field 540, “product” field 541 and “region” field 542. Each widget may be associated with one or more field identifiers. The list of field identifiers may vary depending on the selected dataset and may be scrollable to view all of the available field identifiers.

For some embodiments, some combinations of function and field identifier may require a user to specify additional information to complete the configuration of the widget. For example, when a combination of the “vertical bar chart” widget 459, the “sum” function 511, and the “amount” field 539, the dashboard generator module 303 may display the group display screen 550, shown in FIG. 5C. The group display screen 550 may display all possible groupings 551-561. The group display screen 550 may enable grouping the data in a field corresponding to the selected field identifier. For example, the sum of the amount of opportunities may be grouped by account owner by selecting the “account owner” group 552, as shown in FIG. 5C. The configuration of the “vertical bar chart” widget 459 in this example may also include specifying the order in which the results are displayed. For example, the results may be displayed as a vertical bar chart in ascending order or descending order.

For some embodiments, when the configuration of a widget is complete, another widget may be added to the dashboard. For example, from the display screen 570, the add widget indicator 435 may be selected to enable viewing the widget display screen 450 (shown in FIG. 4C). For some embodiments, there may be multiple add widget indicators to add widgets to different areas of the dashboard. For example, the display screen 570 shows a second add widget indicator 580 and its associated boundary. The size of the boundary may reflect the available widget and the amount of data that is displayed by the associated widget. Thus, the widgets shown in the widget display screen 450 (shown in FIG. 4C) may vary depending whether the add widget indicator 580 or the add widget indicator 435 is selected. For example, the boundary associated with the add widget indicator 580 may only be capable of displaying a short text string or a number instead of a vertical bar chart. The display screen 570 may also include the “cancel” option 425 and the “save” option 430, which may operate as described above with FIG. 4B.

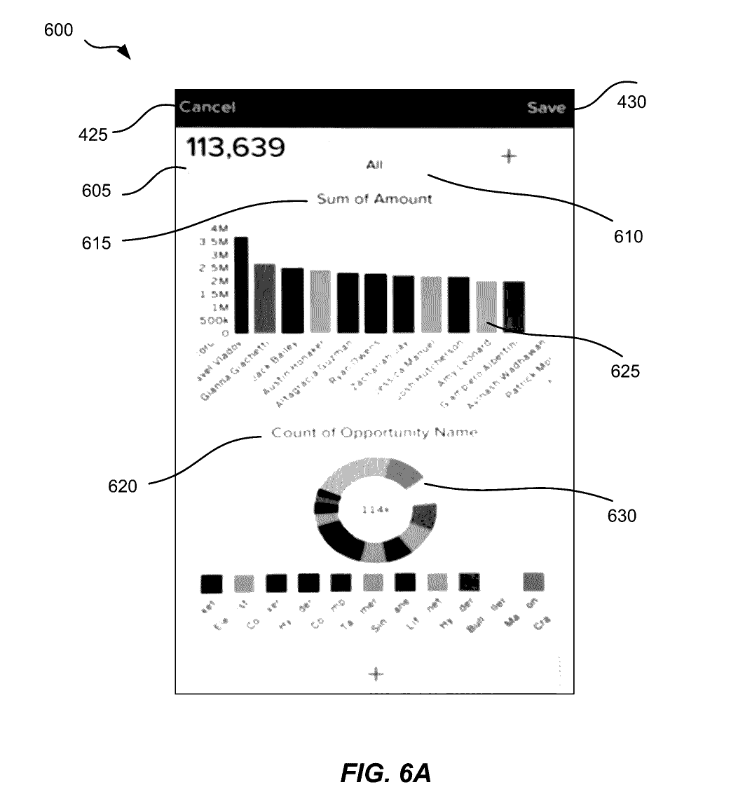

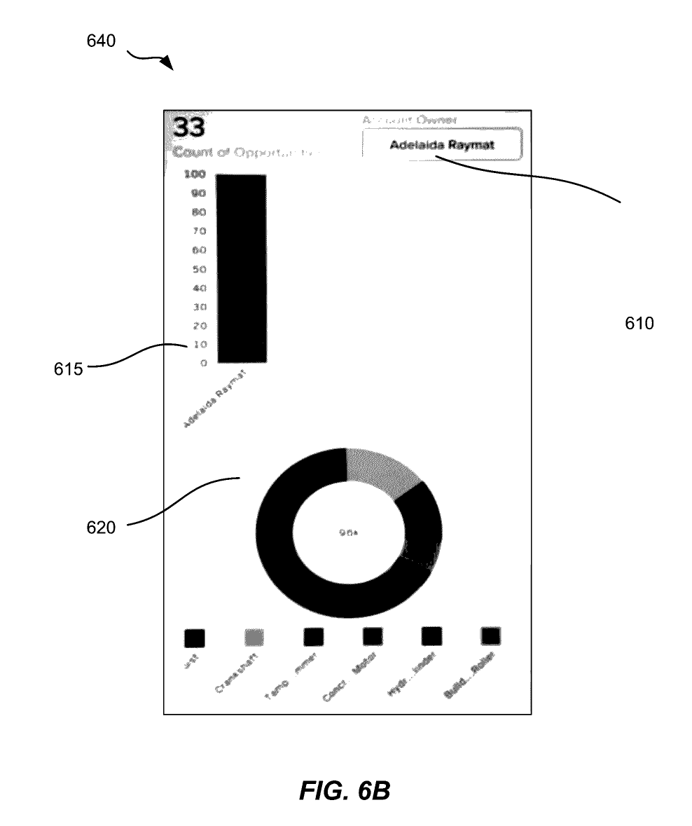

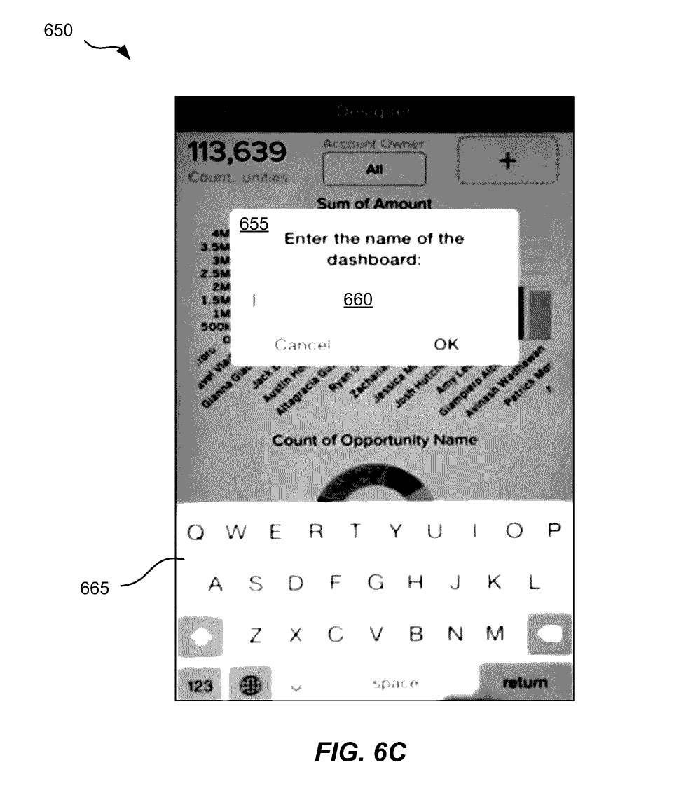

For some embodiments, when all the functions, field identifiers, and related information have been selected or specified for a particular widget, a result associated with the operation of the widget may be shown on the dashboard. For example, when the selection of the “opportunities” dataset 405 (shown in FIG. 4A), the “single number” widget 455 (shown in FIG. 4C), the “count” function 510 (shown in FIG. 5A), and the “opportunities” field 530 (shown in FIG. 5B) are completed, the “count of opportunities” 575 in the “opportunities” dataset 405 is shown on the display screen 570 of FIG. 5D. FIG. 6A illustrates an example of a dashboard after completion of additional widgets, in accordance with some embodiments. Display screen 600 shows count information 605, account owner information 610, vertical bar chart information 615 and pie chart information 620, each information associated with a different widget. It may be noted that the information displayed on the display screen 600 may be scrollable for a more complete view of the dashboard being generated.

For some embodiments, the information displayed by the different widgets may be scrollable. For example, the vertical bar chart information 615 may be scrolled horizontally to display information that may not be visible. For some embodiments, when a particular portion of the vertical bar chart information 615 is selected, more detailed information about that portion may be displayed. For example, when the bar 625 is selected, additional information about the account owner “Amy Leonard” may be displayed by the widget. Similarly, the pie chart information 620 may be rotated and a pie section such as pie section 630 may be selected to view more detailed information. For some embodiments, the information displayed by the different widgets on the same dashboard may be dynamically linked to one another so that there is display consistency among the widgets. For example, when the pie section 630 is selected, the vertical bar chart information 615 may be updated to display information corresponding to the pie section 630.

Referring to FIG. 6A, it may be noted that the widgets associated with the dashboard display “count opportunities” information for all “account owners.” A user of the dashboard may select an area within the boundary of the account owner information 610 to select a specific account owner. FIG. 6B shows an example of the dashboard when the account owner information 610 is updated to a specific account owner, in accordance with some embodiments. Display screen 640 shows the account holder information 610, the vertical bar chart information 615, and the pie chart information 620 displaying consistent information related to a specific account holder.

For some embodiments, the dashboard generator module 303 may display options to save the dashboard when the “save” option 430 is selected. FIG. 6C illustrates an example display screen to save a dashboard, in accordance with some embodiments. Display screen 650 includes a window 655 enabling a user to specify a dashboard name in the input area 660 using the electronic keyboard 665. The saved dashboard may be saved in a local storage of the mobile computing system, and it may be shared with other users for usage with the same dataset that the dashboard is associated with. Sharing may include uploading the dashboard to the server computing system 255 so that others can have access to the dashboard. Sharing may also include emailing the dashboard to other users.

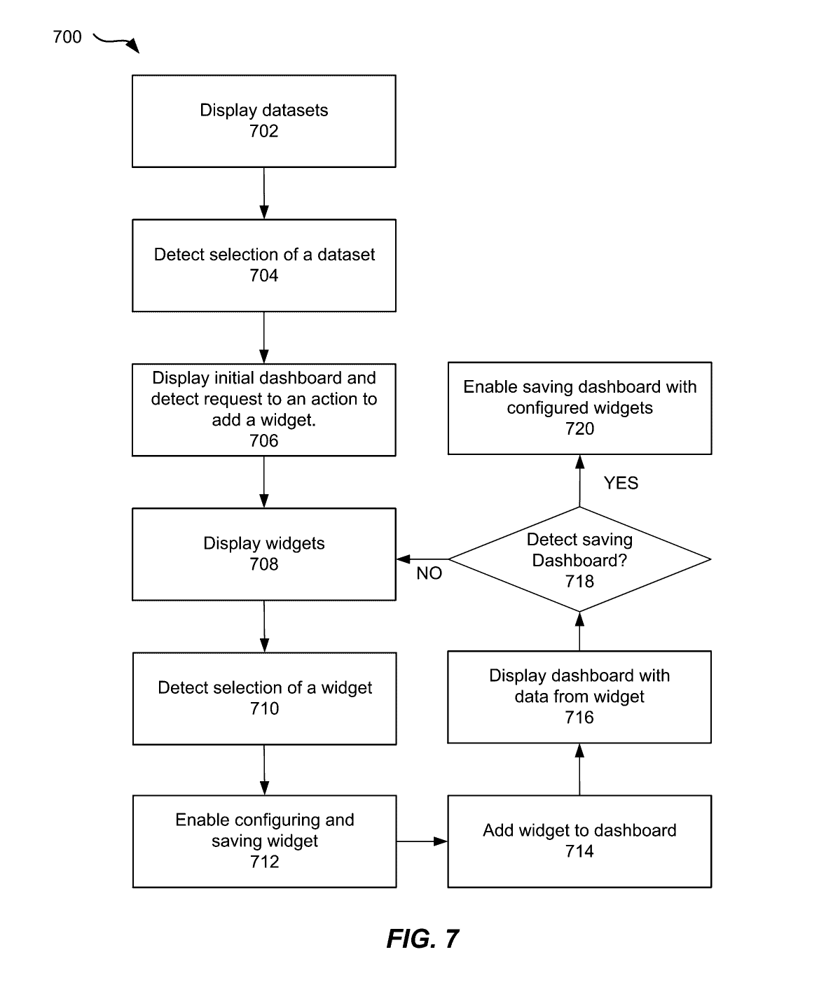

FIG. 7A shows a flowchart of an example process for generating a dashboard when using a mobile computing system, performed in accordance with some embodiments. The process 700 may be performed by the dashboard generator module 303 (shown in FIG. 3) and is described based on a user or a software initiating an action to cause a dashboard to be generated.

At block 702, the dashboard generator module 303 displays one or more datasets that a user of the mobile computing system has access to. The displaying of the datasets may be in response to or based on a request to generate a dashboard. An example of the datasets is shown in FIG. 4A. At block 704, the dashboard generator module 303 may detect a selection of a dataset. At block 706, an initial dashboard may be displayed. The initial dashboard may be blank and may show areas where widgets can be added. The initial dashboard may include one or more add widget indicators to enable adding widgets. An example of the initial dashboard is shown in FIG. 4B. When an add widget indicator is selected, the dashboard generator module 303 may display a set or list of widgets, as shown in block 708. An example of the set of widgets is shown in FIG. 4C. At block 710, the dashboard generator module 303 may detect a selection of a widget. At block 712, the selected widget may be configured based on desired function, field identifier, and related options. At block 714, the widget may be added to the dashboard after its configuration is completed. At block 716, the dashboard may be updated with data from the widget. An example of an updated dashboard is shown in FIG. 6A. At block 718, the dashboard generator module 303 may determine whether the user selects an option to save the dashboard. If the dashboard generator module 303 detects that the user wants to add more widgets, the process may continue at block 708. If a save option is detected, the dashboard generator module 303 may display options to enable the dashboard to be saved, as shown in block 720. An example of the save options is shown in FIG. 6B. After the dashboard is saved, the user may share the dashboard by publishing it or by emailing it to other users.

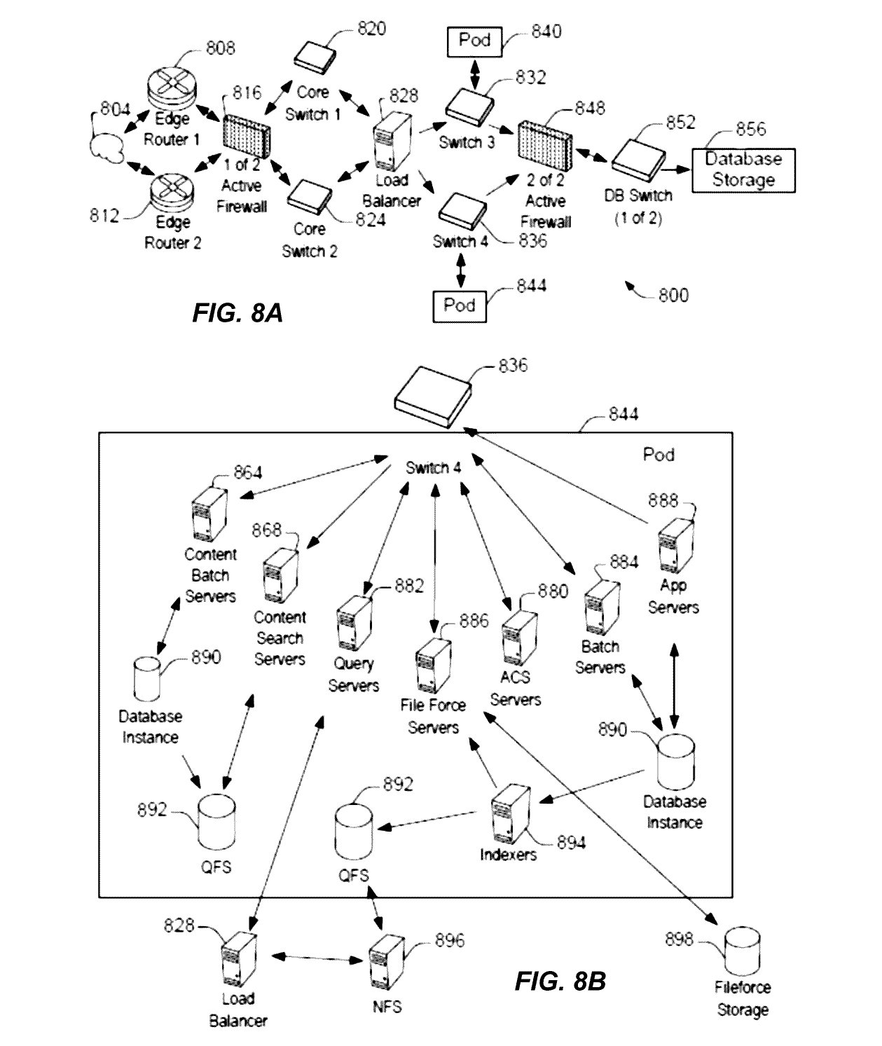

FIG. 8A shows a system diagram 800 illustrating architectural components of an on-demand service environment, in accordance with some embodiments. A client machine located in the cloud 804 (or Internet) may communicate with the on-demand service environment via one or more edge routers 808 and 812. The edge routers may communicate with one or more core switches 820 and 824 via firewall 816. The core switches may communicate with a load balancer 828, which may distribute server load over different pods, such as the pods 840 and 844. The pods 840 and 844, which may each include one or more servers and/or other computing resources, may perform data processing and other operations used to provide on-demand services. Communication with the pods may be conducted via pod switches 832 and 836. Components of the on-demand service environment may communicate with a database storage system 856 via a database firewall 848 and a database switch 852.

As shown in FIGS. 8A and 8B, accessing an on-demand service environment may involve communications transmitted among a variety of different hardware and/or software components. Further, the on-demand service environment 800 is a simplified representation of an actual on-demand service environment. For example, while only one or two devices of each type are shown in FIGS. 8A and 8B, some embodiments of an on-demand service environment may include anywhere from one to many devices of each type. Also, the on-demand service environment need not include each device shown in FIGS. 8A and 8B, or may include additional devices not shown in FIGS. 8A and 8B.

Moreover, one or more of the devices in the on-demand service environment 800 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 804 is intended to refer to a data network or plurality of data networks, often including the Internet. Client machines located in the cloud 804 may communicate with the on-demand service environment to access services provided by the on-demand service environment. For example, client machines may access the on-demand service environment to retrieve, store, edit, and/or process information.

In some embodiments, the edge routers 808 and 812 route packets between the cloud 804 and other components of the on-demand service environment 800. The edge routers 808 and 812 may employ the Border Gateway Protocol (BGP). The BGP is the core routing protocol of the Internet. The edge routers 808 and 812 may maintain a table of IP networks or ‘prefixes’ which designate network reachability among autonomous systems on the Internet.

In one or more embodiments, the firewall 816 may protect the inner components of the on-demand service environment 800 from Internet traffic. The firewall 816 may block, permit, or deny access to the inner components of the on-demand service environment 800 based upon a set of rules and other criteria. The firewall 816 may act as one or more of a packet filter, an application gateway, a stateful filter, a proxy server, or any other type of firewall.

In some embodiments, the core switches 820 and 824 are high-capacity switches that transfer packets within the on-demand service environment 800. The core switches 820 and 824 may be configured as network bridges that quickly route data between different components within the on-demand service environment. In some embodiments, the use of two or more core switches 820 and 824 may provide redundancy and/or reduced latency.

In some embodiments, the pods 840 and 844 may perform the core data processing and service functions provided by the on-demand service environment. Each pod may include various types of hardware and/or software computing resources. An example of the pod architecture is discussed in greater detail with reference to FIG. 8B.

In some embodiments, communication between the pods 840 and 844 may be conducted via the pod switches 832 and 836. The pod switches 832 and 836 may facilitate communication between the pods 840 and 844 and client machines located in the cloud 804, for example via core switches 820 and 824. Also, the pod switches 832 and 836 may facilitate communication between the pods 840 and 844 and the database storage 856.

In some embodiments, the load balancer 828 may distribute workload between the pods 840 and 844. Balancing the on-demand service requests between the pods may assist in improving the use of resources, increasing throughput, reducing response times, and/or reducing overhead. The load balancer 828 may include multilayer switches to analyze and forward traffic.

In some embodiments, access to the database storage 856 may be guarded by a database firewall 848. The database firewall 848 may act as a computer application firewall operating at the database application layer of a protocol stack. The database firewall 848 may protect the database storage 856 from application attacks such as structure query language (SQL) injection, database rootkits, and unauthorized information disclosure.

In some embodiments, the database firewall 848 may include a host using one or more forms of reverse proxy services to proxy traffic before passing it to a gateway router. The database firewall 848 may inspect the contents of database traffic and block certain content or database requests. The database firewall 848 may work on the SQL application level atop the TCP/IP stack, managing applications' connection to the database or SQL management interfaces as well as intercepting and enforcing packets traveling to or from a database network or application interface.

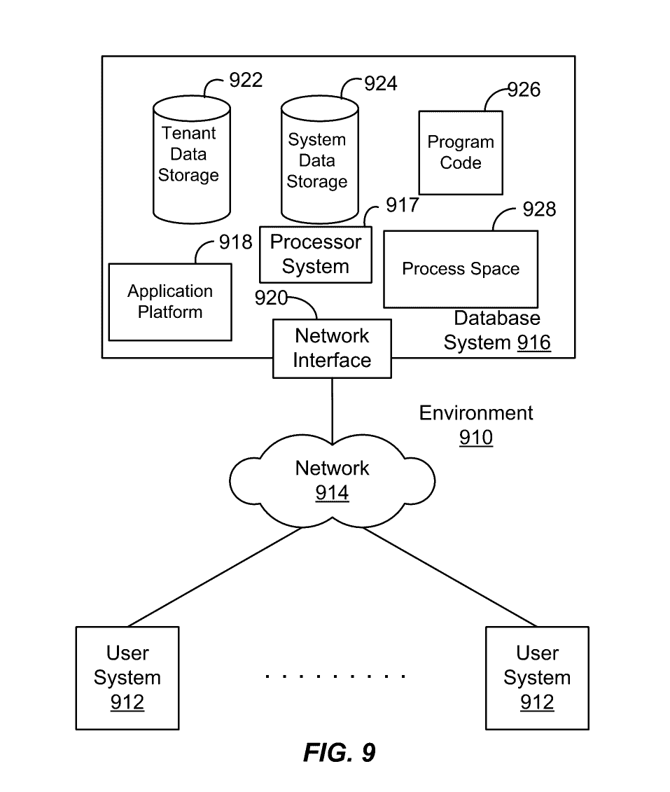

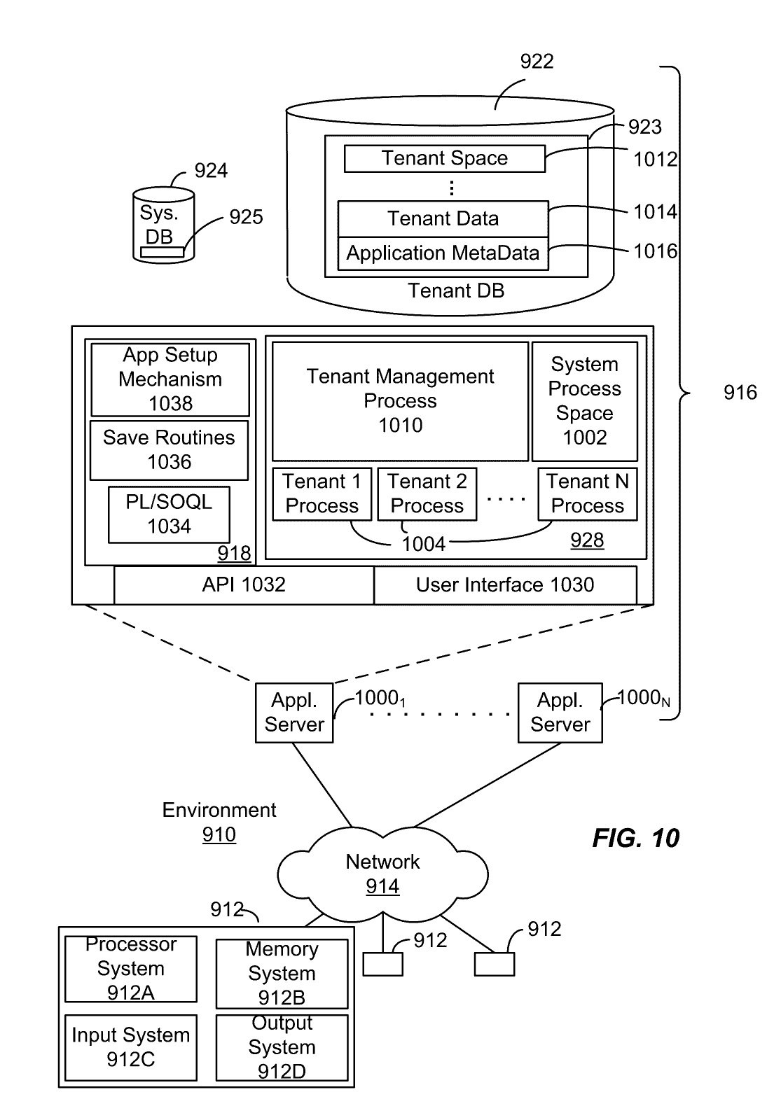

In some embodiments, communication with the database storage system 856 may be conducted via the database switch 852. The multi-tenant database system 856 may include more than one hardware and/or software components for handling database queries. Accordingly, the database switch 852 may direct database queries transmitted by other components of the on-demand service environment (e.g., the pods 840 and 844) to the correct components within the database storage system 856. In some embodiments, the database storage system 856 is an on-demand database system shared by many different organizations. The on-demand database system may employ a multi-tenant approach, a virtualized approach, or any other type of database approach. An on-demand database system is discussed in greater detail with reference to FIGS. 9 and 10.

FIG. 8B shows a system diagram illustrating the architecture of the pod 844, in accordance with one embodiment. The pod 844 may be used to render services to a user of the on-demand service environment 800. In some embodiments, each pod may include a variety of servers and/or other systems. The pod 844 includes one or more content batch servers 864, content search servers 868, query servers 872, file force servers 876, access control system (ACS) servers 880, batch servers 884, and app servers 888. Also, the pod 844 includes database instances 890, quick file systems (QFS) 892, and indexers 894. In one or more embodiments, some or all communication between the servers in the pod 844 may be transmitted via the switch 836.

In some embodiments, the application servers 888 may include a hardware and/or software framework dedicated to the execution of procedures (e.g., programs, routines, scripts) for supporting the construction of applications provided by the on-demand service environment 800 via the pod 844. Some such procedures may include operations for providing the services described herein. The content batch servers 864 may requests internal to the pod. These requests may be long-running and/or not tied to a particular customer. For example, the content batch servers 864 may handle requests related to log mining, cleanup work, and maintenance tasks.

The content search servers 868 may provide query and indexer functions. For example, the functions provided by the content search servers 868 may allow users to search through content stored in the on-demand service environment. The Fileforce servers 876 may manage requests information stored in the Fileforce storage 878. The Fileforce storage 878 may store information such as documents, images, and basic large objects (BLOBs). By managing requests for information using the Fileforce servers 876, the image footprint on the database may be reduced.

The query servers 872 may be used to retrieve information from one or more file systems. For example, the query system 872 may receive requests for information from the app servers 888 and then transmit information queries to the NFS 896 located outside the pod. The pod 844 may share a database instance 890 configured as a multi-tenant environment in which different organizations share access to the same database. Additionally, services rendered by the pod 844 may require various hardware and/or software resources. In some embodiments, the ACS servers 880 may control access to data, hardware resources, or software resources.

In some embodiments, the batch servers 884 may process batch jobs, which are used to run tasks at specified times. Thus, the batch servers 884 may transmit instructions to other servers, such as the app servers 888, to trigger the batch jobs. In some embodiments, the QFS 892 may be an open source file system available from Sun Microsystems® of Santa Clara, Calif. The QFS may serve as a rapid-access file system for storing and accessing information available within the pod 844. The QFS 892 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 868 and/or indexers 894 to identify, retrieve, move, and/or update data stored in the network file systems 896 and/or other storage systems.

In some embodiments, one or more query servers 872 may communicate with the NFS 896 to retrieve and/or update information stored outside of the pod 844. The NFS 896 may allow servers located in the pod 844 to access information to access files over a network in a manner similar to how local storage is accessed. In some embodiments, queries from the query servers 822 may be transmitted to the NFS 896 via the load balancer 820, which may distribute resource requests over various resources available in the on-demand service environment. The NFS 896 may also communicate with the QFS 892 to update the information stored on the NFS 896 and/or to provide information to the QFS 892 for use by servers located within the pod 844.

In some embodiments, the pod may include one or more database instances 890. The database instance 890 may transmit information to the QFS 892. When information is transmitted to the QFS, it may be available for use by servers within the pod 844 without requiring an additional database call. In some embodiments, database information may be transmitted to the indexer 894. Indexer 894 may provide an index of information available in the database 890 and/or QFS 892. The index information may be provided to file force servers 876 and/or the QFS 892.

FIG. 9 shows a block diagram of an environment 910 wherein an on-demand database service might be used, in accordance with some embodiments. Environment 910 includes an on-demand database service 916. User system 912 may be any machine or system that is used by a user to access a database user system. For example, any of user systems 912 can be a handheld computing system, a mobile phone, a laptop computer, a work station, and/or a network of computing systems. As illustrated in FIGS. 9 and 10, user systems 912 might interact via a network 914 with the on-demand database service 916.

An on-demand database service, such as system 916, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 916” and “system 916” will be used interchangeably herein. A database image may include one or more database objects. A relational database management system (RDBMS) or the equivalent may execute storage and retrieval of information against the database object(s). Application platform 918 may be a framework that allows the applications of system 916 to run, such as the hardware and/or software, e.g., the operating system. In an implementation, on-demand database service 916 may include an application platform 918 that enables creation, managing and executing one or more applications developed by the provider of the on-demand database service, users accessing the on-demand database service via user systems 912, or third party application developers accessing the on-demand database service via user systems 912.

One arrangement for elements of system 916 is shown in FIG. 9, including a network interface 920, application platform 918, tenant data storage 922 for tenant data 923, system data storage 924 for system data 925 accessible to system 916 and possibly multiple tenants, program code 926 for implementing various functions of system 916, and a process space 928 for executing MTS system processes and tenant-specific processes, such as running applications as part of an application hosting service. Additional processes that may execute on system 916 include database indexing processes.

The users of user systems 912 may differ in their respective capacities, and the capacity of a particular user system 912 might be entirely determined by permissions (permission levels) for the current user. For example, where a call center agent is using a particular user system 912 to interact with system 916, the user system 912 has the capacities allotted to that call center agent. However, while an administrator is using that user system to interact with system 916, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level.

Network 914 is any network or combination of networks of devices that communicate with one another. For example, network 914 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network (e.g., the Internet), that network will be used in many of the examples herein. However, it should be understood that the networks used in some embodiments are not so limited, although TCP/IP is a frequently implemented protocol.

User systems 912 might communicate with system 916 using TCP/IP and, at a higher network level, use other common Internet protocols to communicate, such as HTTP, FTP, AFS, WAP, etc. In an example where HTTP is used, user system 912 might include an HTTP client commonly referred to as a “browser” for sending and receiving HTTP messages to and from an HTTP server at system 916. Such an HTTP server might be implemented as the sole network interface between system 916 and network 914, but other techniques might be used as well or instead. In some embodiments, the interface between system 916 and network 914 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In some embodiments, system 916, shown in FIG. 9, implements a web-based customer relationship management (CRM) system. For example, in some embodiments, system 916 includes application servers configured to implement and execute CRM software applications as well as provide related data, code, forms, web pages and other information to and from user systems 912 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 916 implements applications other than, or in addition to, a CRM application. For example, system 916 may provide tenant access to multiple hosted (standard and custom) applications. User (or third party developer) applications, which may or may not include CRM, may be supported by the application platform 918, which manages creation, storage of the applications into one or more database objects and executing of the applications in a virtual machine in the process space of the system 916.

Each user system 912 could include a desktop personal computer, workstation, laptop, PDA, cell phone, or any wireless access protocol (WAP) enabled device or any other computing system capable of interfacing directly or indirectly to the Internet or other network connection. User system 912 typically runs an HTTP client, e.g., a browsing program, such as Microsoft's Internet Explorer® browser, Mozilla's Firefox® browser, Opera's browser, or a WAP-enabled browser in the case of a cell phone, PDA or other wireless device, or the like, allowing a user (e.g., subscriber of the multi-tenant database system) of user system 912 to access, process and view information, pages and applications available to it from system 916 over network 914.

Each user system 912 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 916 or other systems or servers. For example, the user interface device can be used to access data and applications hosted by system 916, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to some embodiments, each user system 912 and all of its components are operator configurable using applications, such as a browser, including computer code run using a central processing unit such as an Intel Pentium® processor or the like. Similarly, system 916 (and additional instances of an MTS, where more than one is present) and all of their components might be operator configurable using application(s) including computer code to run using a central processing unit such as processor system 917, which may include an Intel Pentium® processor or the like, and/or multiple processor units.

A computer program product implementation includes a machine-readable storage medium (media) having instructions stored thereon/in which can be used to program a computer to perform any of the processes of the embodiments described herein. Computer code for operating and configuring system 916 to intercommunicate and to process web pages, applications and other data and media content as described herein are preferably downloaded and stored on a hard disk, but the entire program code, or portions thereof, may also be stored in any other volatile or non-volatile memory medium or device, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, or transmitted over any other conventional network connection (e.g., extranet, VPN, LAN, etc.) using any communication medium and protocols (e.g., TCP/IP, HTTP, HTTPS, Ethernet, etc.). It will also be appreciated that computer code for implementing embodiments can be implemented in any programming language that can be executed on a client system and/or server or server system such as, for example, C, C++, HTML, any other markup language, Java™, JavaScript®, ActiveX®, any other scripting language, such as VBScript, and many other programming languages as are well known may be used. (Java™ is a trademark of Sun Microsystems®, Inc.).

According to some embodiments, each system 916 is configured to provide web pages, forms, applications, data and media content to user (client) systems 912 to support the access by user systems 912 as tenants of system 916. As such, system 916 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include logically and/or physically connected servers distributed locally or across one or more geographic locations. Additionally, the term “server” is meant to include a computing system, including processing hardware and process space(s), and an associated storage system and database application (e.g., OODBMS or RDBMS) as is well known in the art.

It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 10 also shows a block diagram of environment 910 further illustrating system 916 and various interconnections, in accordance with some embodiments. FIG. 10 shows that user system 912 may include processor system 912A, memory system 912B, input system 912C, and output system 912D. FIG. 10 shows network 914 and system 916. FIG. 10 also shows that system 916 may include tenant data storage 922, tenant data 923, system data storage 924, system data 925, User Interface (UI) 1030, Application Program Interface (API) 1032, PL/SOQL 1034, save routines 1036, application setup mechanism 1038, applications servers 10001-1000N, system process space 1002, tenant process spaces 1004, tenant management process space 1010, tenant storage area 1012, user storage 1014, and application metadata 1016. In other embodiments, environment 910 may not have the same elements as those listed above and/or may have other elements instead of, or in addition to, those listed above.

User system 912, network 914, system 916, tenant data storage 922, and system data storage 924 were discussed above in FIG. 9. Regarding user system 912, processor system 912A may be any combination of processors. Memory system 912B may be any combination of one or more memory devices, short term, and/or long term memory. Input system 912C may be any combination of input devices, such as keyboards, mice, trackballs, scanners, cameras, and/or interfaces to networks. Output system 912D may be any combination of output devices, such as monitors, printers, and/or interfaces to networks. As shown by FIG. 10, system 916 may include a network interface 920 (of FIG. 9) implemented as a set of HTTP application servers 1000, an application platform 918, tenant data storage 922, and system data storage 924. Also shown is system process space 1002, including individual tenant process spaces 1004 and a tenant management process space 1010. Each application server 1000 may be configured to tenant data storage 922 and the tenant data 923 therein, and system data storage 924 and the system data 925 therein to serve requests of user systems 912. The tenant data 923 might be divided into individual tenant storage areas 1012, which can be either a physical arrangement and/or a logical arrangement of data. Within each tenant storage area 1012, user storage 1014 and application metadata 1016 might be similarly allocated for each user. For example, a copy of a user's most recently used (MRU) items might be stored to user storage 1014. Similarly, a copy of MRU items for an entire organization that is a tenant might be stored to tenant storage area 1012. A UI 1030 provides a user interface and an API 1032 provides an application programmer interface to system 916 resident processes to users and/or developers at user systems 912. The tenant data and the system data may be stored in various databases, such as Oracle™ databases.

Application platform 918 includes an application setup mechanism 1038 that supports application developers' creation and management of applications, which may be saved as metadata into tenant data storage 922 by save routines 1036 for execution by subscribers as tenant process spaces 1004 managed by tenant management process 1010 for example. Invocations to such applications may be coded using PL/SOQL 34 that provides a programming language style interface extension to API 1032. A detailed description of some PL/SOQL language embodiments is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is hereby incorporated by reference in its entirety and for all purposes. Invocations to applications may be detected by system processes, which manage retrieving application metadata 1016 for the subscriber making the invocation and executing the metadata as an application in a virtual machine.

Each application server 1000 may be communicably coupled to database systems, e.g., having access to system data 925 and tenant data 923, via a different network connection. For example, one application server 10001 might be coupled via the network 914 (e.g., the Internet), another application server 1000N-1 might be coupled via a direct network link, and another application server 1000N might be coupled by yet a different network connection. Transfer Control Protocol and Internet Protocol (TCP/IP) are typical protocols for communicating between application servers 1000 and the database system. However, other transport protocols may be used to optimize the system depending on the network interconnect used.

In certain embodiments, each application server 1000 is configured to handle requests for any user associated with any organization that is a tenant. Because it is desirable to be able to add and remove application servers from the server pool at any time for any reason, there is preferably no server affinity for a user and/or organization to a specific application server 1000. In some embodiments, therefore, an interface system implementing a load balancing function (e.g., an F5 Big-IP load balancer) is communicably coupled between the application servers 1000 and the user systems 912 to distribute requests to the application servers 1000. In some embodiments, the load balancer uses a least connections algorithm to route user requests to the application servers 1000. Other examples of load balancing algorithms, such as round robin and observed response time, also can be used. For example, in certain embodiments, three consecutive requests from the same user could hit three different application servers 1000, and three requests from different users could hit the same application server 1000. In this manner, system 916 is multi-tenant, wherein system 916 handles storage of, and access to, different objects, data and applications across disparate users and organizations.

As an example of storage, one tenant might be a company that employs a sales force where each call center agent uses system 916 to manage their sales process. Thus, a user might maintain contact data, leads data, customer follow-up data, performance data, goals and progress data, etc., all applicable to that user's personal sales process (e.g., in tenant data storage 922). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a call center agent is visiting a customer and the customer has Internet access in their lobby, the call center agent can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant Thus, there might be some data structures managed by system 916 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 916 might also maintain system level data usable by multiple tenants or other data. Such system level data might include industry reports, news, postings, and the like that are sharable among tenants.

In certain embodiments, user systems 912 (which may be client machines/systems) communicate with application servers 1000 to request and update system-level and tenant-level data from system 916 that may require sending one or more queries to tenant data storage 922 and/or system data storage 924. System 916 (e.g., an application server 1000 in system 916) automatically generates one or more SQL statements (e.g., SQL queries) that are designed to access the desired information. System data storage 924 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some embodiments. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for account, contact, lead, and opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, titled CUSTOM ENTITIES AND FIELDS IN A MULTI-TENANT DATABASE SYSTEM, by Weissman, et al., and which is hereby incorporated by reference in its entirety and for all purposes, teaches systems and methods for creating custom objects as well as customizing standard objects in a multi-tenant database system. In some embodiments, for example, all custom entity data rows are stored in a single multi-tenant physical table, which may contain multiple logical tables per organization. In some embodiments, multiple “tables” for a single customer may actually be stored in one large table and/or in the same table as the data of other customers.

These and other aspects of the disclosure may be implemented by various types of hardware, software, firmware, etc. For example, some features of the disclosure may be implemented, at least in part, by machine-readable media that include program instructions, state information, etc., for performing various operations described herein. Examples of program instructions include both machine code, such as produced by a compiler, and files containing higher-level code that may be executed by the computer using an interpreter. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

While one or more embodiments and techniques are described with reference to an implementation in which a service cloud console is implemented in a system having an application server providing a front end for an on-demand database service capable of supporting multiple tenants, the one or more embodiments and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While various embodiments have been described herein, it should be understood that they have been presented by way of example only, and not limitation. Thus, the breadth and scope of the present application should not be limited by any of the embodiments described herein, but should be defined only in accordance with the following and later-submitted claims and their equivalents.

What is claimed is:

1. A computer-implemented method for generating a dashboard using a display screen of a mobile computing system, the method comprising:
displaying one or more dataset identifiers on a display screen of a mobile computing system;
displaying one or more widgets on the display screen of the mobile computing system in response to a selection of a dataset identifier by a user of the mobile computing system;
configuring the first widget to operate with a dataset associated with the selected dataset identifier in response to a selection of a first widget by a user of the mobile computing system;
adding the first widget to the dashboard when the first widget is configured to operate with the dataset associated with the selected dataset identifier; and
enabling data in the dataset to be displayed on the display screen of the mobile computing system in response to selection of the first widget by the user.

2. The method of claim 1, wherein configuring the first widget to operate with the first dataset comprises associating the first widget with at least one function related to operation of the first widget.

3. The method of claim 2, wherein configuring the first widget to operate with the first dataset comprises associating the first widget with at least one field of the dataset.

4. The method of claim 3, further comprising displaying a result associated with the operation of the first widget in the dashboard based on completion of configuring of the first widget.

5. The method of claim 4, wherein the result associated with the operation of the first widget is displayed within a boundary associated with the first widget.

6. The method of claim 5, further comprising enabling a selection of a second widget based on adding the first widget to the dashboard.

7. The method of claim 6, further comprising:
based on detecting the selection of the second widget, configuring the second widget to operate with the dataset associated with the selected dataset identifier; and
adding the second widget to the dashboard based on completion of configuring of the second widget.

8. The method of claim 7, wherein operation of the second widget is dynamically linked to operation of the first widget.

9. An apparatus to generate a dashboard using a display screen of a mobile computing system, the apparatus comprising:
a processor; and
one or more stored sequences of instructions which, when executed by the processor, cause the processor to:
display one or more dataset identifiers on a display screen of a mobile computing system;
display one or more widgets on the display screen of the mobile computing system in response to a selection of a dataset identifier by a user of the mobile computing system;
configure the first widget to operate with a dataset associated with the selected dataset identifier in response to a selection of a first widget by a user of the mobile computing system;
add the first widget to the dashboard when the first widget is configured to operate with the dataset associated with the selected dataset identifier; and
enable data in the dataset to be displayed on the display screen of the mobile computing system in response to selection of the first widget by the user.

10. The apparatus of claim 9, wherein configuring the first widget to operate with the first dataset comprises associating the first widget with at least one function related to operation of the first widget.

11. The apparatus of claim 10, wherein configuring the first widget to operate with the first dataset comprises associating the first widget with at least one field of the dataset.

12. The apparatus of claim 11, further comprising displaying a result associated with the operation of the first widget in the dashboard based on completion of configuring of the first widget.

13. The apparatus of claim 12, wherein the result associated with the operation of the first widget is displayed within a boundary associated with the first widget.

14. The apparatus of claim 13, further comprising enabling a selection of a second widget based on adding the first widget to the dashboard.

15. The apparatus of claim 14, further comprising:
based on detecting the selection of the second widget, configuring the second widget to operate with the dataset associated with the selected dataset identifier; and
adding the second widget to the dashboard based on completion of configuring of the second widget.

16. The apparatus of claim 15, wherein operation of the second widget is dynamically linked to operation of the first widget.

17. A computer program product comprising computer-readable program code to be executed by one or more processors when retrieved from a non-transitory computer-readable medium, the program code including instructions to:
display one or more dataset identifiers on a display screen of a mobile computing system;
display one or more widgets on the display screen of the mobile computing system in response to a selection of a dataset identifier by a user of the mobile computing system;
configure the first widget to operate with a dataset associated with the selected dataset identifier in response to a selection of a first widget by a user of the mobile computing system;
add the first widget to the dashboard when the first widget is configured to operate with the dataset associated with the selected dataset identifier; and
enable data in the dataset to be displayed on the display screen of the mobile computing system in response to selection of the first widget by the user.

18. The computer program product of claim 17, wherein configuring the first widget to operate with the first dataset comprises associating the first widget with at least one function related to operation of the first widget, and wherein configuring the first widget to operate with the first dataset comprises associating the first widget with at least one field of the dataset.

19. The computer program product of claim 18, further comprising displaying a result associated with the operation of the first widget in the dashboard based on completion of configuring of the first widget, wherein the result associated with the operation of the first widget is displayed within a boundary associated with the first widget.

20. The computer program product of claim 19, further comprising:
enabling a selection of a second widget based on adding the first widget to the dashboard;
based on detecting the selection of the second widget, configuring the second widget to operate with the dataset associated with the selected dataset identifier; and
adding the second widget to the dashboard based on completion of configuring of the second widget, wherein operation of the second widget is dynamically linked to operation of the first widget.
